(19) United States
(12) Patent Application Publication
(10) Pub. No.: US 2009/0076879 A1
(43) Pub. Date: Mar. 19, 2009

(54) System and method for deployment and financing of a security system

(76) Inventors: Collier Sparks, Helotes, TX (US); Jim Vandevere, San Antonio, TX (US)

Correspondence Address: George R. Schultz;Schultz & Associates, P.C., One Lincoln Centre, 54oo LBJ Freeway, Suite 1200, Dallas, TX, 75240, US

(21) Appl. No.: 11/903,125

(22) Filed: Sep. 19, 2007

(51) Int. Cl. G06Q 10/00; G06F 17/00; G06F 17/40

(52) U.S. Cl. 705/9; 705/7; 705/8

(57) ABSTRACT

A method is provided to itemize, install, finance and monitor a security system on a school campus. A behavioral recognition training program for administration and staff is provided. A set of financing options is provided that minimizes or eliminates the burden placed on the school district for payment and maintenance of the security system.

### COPYRIGHT NOTICE

A portion of the disclosure of this patent document contains material which is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### FIELD OF THE INVENTION

The present invention relates to the deployment and financing of a comprehensive security program for a school campus. In particular, the invention is a method of implementation of a security program that provides a combination of physical security for school campuses, training of personnel and novel financing methods.

### BACKGROUND OF THE INVENTION

Our nation's education system contends with unprecedented security challenges today. Schools for all ages of children and in diverse geographic locations have become the backdrops of horrific violence. Never before have children faced such danger in places such as schools.

In response to the security challenges faced by schools, many state and local governments have implemented security audit procedures and security requirements for schools. Examples are Texas Senate Bill 9, S.B. 9 80(R) (Tx. 2007) and Texas Senate Bill 11, S.B. 11 80(R) (Tx. 2007), passed by the Texas Legislature in 2007. These bills, and others like them, require schools to conduct a security audit to locate vulnerabilities to students, faculty and school campuses.

Unfortunately, at the same time as security requirements are increasing, school budgets are decreasing. Generally schools are faced with higher student loads, increased educational demands, increased employee expenses and increased equipment costs to administer and carry out their educational functions. Many times these increasing financial pressures severely limit or prevent the installation of expensive access control systems and the employment of trained security personnel which are required to implement an effective security system in a school.

Prior art security systems for a school typically include the access control system such as video cameras and sensors, card readers, badges and portals, the software and computer network that provides database storage and data communication and importantly the personnel to provide the physical security of the building and the people in it. Typically, each school district is responsible for the purchase, administration and maintenance of the security system. Additionally, a school district typically provides non-educational administrative services. Examples are employee health insurance and benefits, employee payroll, student transportation, facility maintenance, and cafeteria services. Each school district duplicates many of the same administrative functions creating redundancy and overlap. Overlap of redundant administrative operations create inefficiencies. The inefficiencies are expensive and reduce the ability of each of the school district to provide other education related functions and to provide security systems.

### SUMMARY OF THE INVENTION

The present invention provides a system and method to implement and fund a security system in a school district which can be customized to meet the demographics, behavioral dynamics and threat level of each school system and that meets the requirements of federal, state and local laws. The invention includes a method designed to minimize the risk of violence and misconduct in a school district by analyzing the needs of the school district and supplying a security system through outsourcing of various non-teaching related administrative tasks of the school district and centralizing them with a single security system provider realizing a savings. The savings is used to fund and support the security system.

Accordingly, an embodiment of the present invention provides a method for the deployment of a security system for school districts. A “security system” includes an access control system, a supporting computer network and security personnel such as IT support and security guards. The method includes conducting a site survey where the physical layout of a school and the current level of security is assessed. The site survey also includes an audit of scalable administrative functions. The site survey further includes a risk assessment where the vulnerabilities of the existing physical security system are studied. Funding options are evaluated. Notably, among the funding options is the outsourcing of the scalable administrative functions to a security system provider. A deployment contract is negotiated including an identification of the components of the access control system, security personnel and scalable administrative functions to be outsourced. After contract closing, a set of engineering and installation teams are identified. Security background checks of all members of the engineering and installation teams are performed. A database of acceptable engineers and installers is created.

The engineering team itemizes equipment and identifies appropriate prepackaged design modules. Required custom designs are identified. The design modules are palletized and prepared for shipping. Shipment is coordinated with other shipping requirements to minimize cost.

The installation team is deployed. The installation team unpacks and verifies the design modules and installs the access control system. Network communication is verified. All school faculty, employees and students undergo a citizenship check, a social security check, a motor vehicle report, a credit report, and is fingerprinted all in order to create a personal file and an ID badge. The badging process includes the steps of photographing the staff students, and the parents. A visitor control system creates temporary ID badges as needed for parents and visitors.

School employees are trained to use all the features of the newly installed hardware and software systems. Faculty and administration undergo behavioral anomaly recognition training from trained criminal and behavioral psychologists. Administrators and faculty are taught how to recognize potentially dangerous individuals, locations and situations in an effort to prevent security breaches from occurring.

The method includes computer network monitoring of the access control system by the security system provider. The method further includes the assumption of the scalable administrative functions of the school district and combining them with other similar tasks from several school districts to realize a savings in money and time through consolidation. The savings in money spent by the school district is used to implement the security system or to reduce its cost to the school district. System maintenance and upgrades are performed on a predetermined schedule or on an as needed basis.

Those skilled in the art will appreciate the features and advantages of the invention together with other important aspects upon reading the detailed description that follows in conjunction with the figures provided.

### BRIEF DESCRIPTION OF THE DRAWINGS

FIG. 1 is a schematic drawing of a computerized security system as is known in the prior art for a single school campus.

FIG. 2 is a schematic drawing of a computer communications network connecting several security systems as is known in the prior art.

FIG. 3 is a flow diagram of the steps for deployment and financing of a security system.

FIG. 4 is a flow diagram of the steps for conducting a site survey and generating a site survey report.

FIG. 5 is a flow diagram of the steps for contract negotiation and closing.

FIG. 6 is a flow diagram of the steps for security engineering and system design.

FIG. 7 is a flow diagram of the steps for coordinating system assembly and shipment.

FIG. 8 is a flow diagram of the steps for installing the components of the access control system.

FIG. 9 is a flow diagram of the steps for implementing staff and student badging.

### DETAILED DESCRIPTION OF THE PREFERRED EMBODIMENT

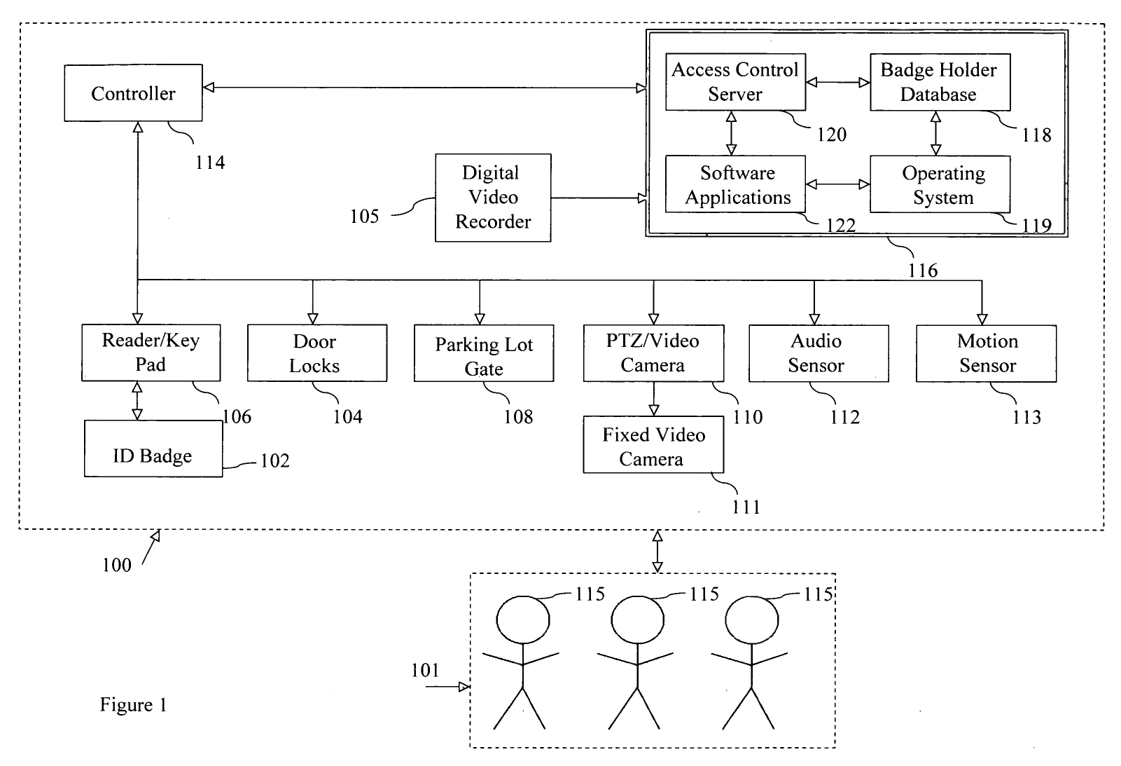

Embodiments of the present invention and its advantages are best understood by referring to FIGS. 1 through 9, like numerals being used for like and corresponding parts of the various drawings.

A schematic of the typical components of a prior art security system are shown in FIG. 1. The security system includes computerized access control system 100 and a set of security personnel 101. Access control system 100 includes a computer system 116. The computer system is housed in a physically secure location and monitored for tampering. Computer system 116 comprises a server including a badge holder database 118, software applications 122, operating system 119 access control server 120 and digital video recorder 105. Badge holder database 118 includes a series of fields storing identifying information related to various authenticated and unauthenticated cardholders such as PIN numbers, fingerprint data, and encryption passwords. Software applications 122 run in the operating system environment and comprise executable files necessary to access the database, initiate network communication and run various applications necessary to the functioning of the access control system. Badge holder database 118 and software applications 122 are held in data communication with access control server 120. Access control server 120 is a hardware and software system which allows network communication with controller 114. Controller 114 also communicates information to and receives information from reader/key pad 106, door locks 104, parking lot gate 108, PTZ video camera 110, fixed security camera 111, audio sensor 112, and motion sensor 113. Reader/key pad 106 communicates user information read from an ID badge 102 and user entered information to controller 114 which operates to door locks 104 and parking lot gate 108 to admit or deny access. Information gathered from video camera 110, audio sensor 112, and motion sensor 113 is communicated through controller 114 and stored in computer system 116. An example of an access control system is the Safenet® System provided by MDI, Inc. of San Antonio, Tex.

Set of security personnel 101 typically includes personnel 115 to install and maintain the access control system 100 and also to provide physical security such as security guards and parking attendants.

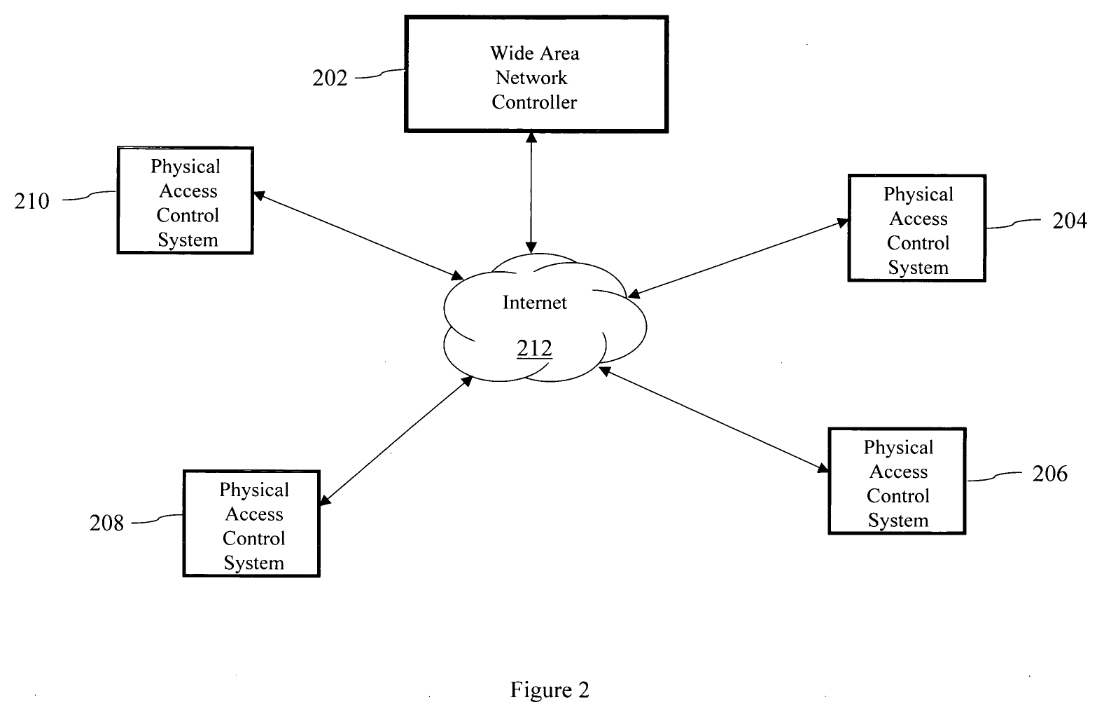

FIG. 2 shows a schematic diagram of multiple physical access control systems connected to a wide area network (WAN) controller 202 via the Internet 212. Internet 212 is connected to the geographically distinct local controllers of physical access control systems 204, 206, 208, and 210. Each local physical access control system includes a network controller capable of communicating access control information to wide area network controller 202 through Internet 212. As is known, data communication occurs through TCP/IP protocol and may include data packets, streaming video data, audio data or systems operation data such as override commands to door locks and positioning and pre-shot locations for PTZ video camera positioning devices. In a system as shown in FIG. 2, various functions of monitoring and controlling the multiple physical access control systems are carried out by the wide area network controller.

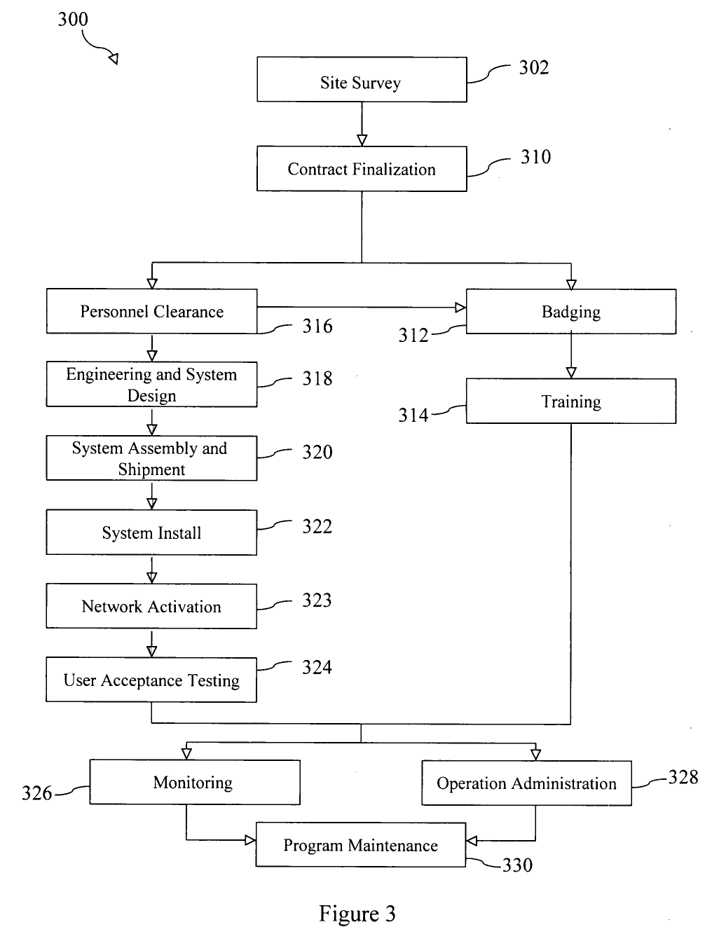

Referring now to FIG. 3, there is shown an operational flow chart of a preferred method for the deployment of a security system for school campuses. Various steps of the method will be further described later in reference to more detailed figures. Method 300 begins with site survey step 302. Site survey step 302 entails an observation of the existing physical buildings and security system provided by the school district and an audit of scalable administrative functions. A risk assessment is performed to determine the security vulnerabilities of the school campus from the site survey. Available funding options are examined and a contract is negotiated between the security system provider and the school district and executed in step 310. In step 316, the engineering team and the installation team are identified and screened.

The engineering team performs engineering and system design in step 318. In step 320 the design modules are palletized and shipped. Once the shipment reaches the school in step 322, the pallet contents are verified against the design plan. After the equipment and software is installed, network activation occurs in step 323. After the network is activated, user acceptance and testing occurs in step 324. Badging of students and school employees occurs at badging step 312. In training step 314 administrators and teaching staff are trained on how to recognize and ideally prevent potential security breaches before they occur. In this step school employees are also trained in operation of security system hardware and software. In step 326, the security system is activated and monitoring begins. At step 328, outsourcing of the administrative tasks identified in the administrative audit takes place to the security system provider.

An alternate embodiment includes program maintenance step 330. In this step, the security system provider returns to the school campus at predetermined intervals to assess the state of the security system, train recently hired faculty, and install additional security equipment or upgrades.

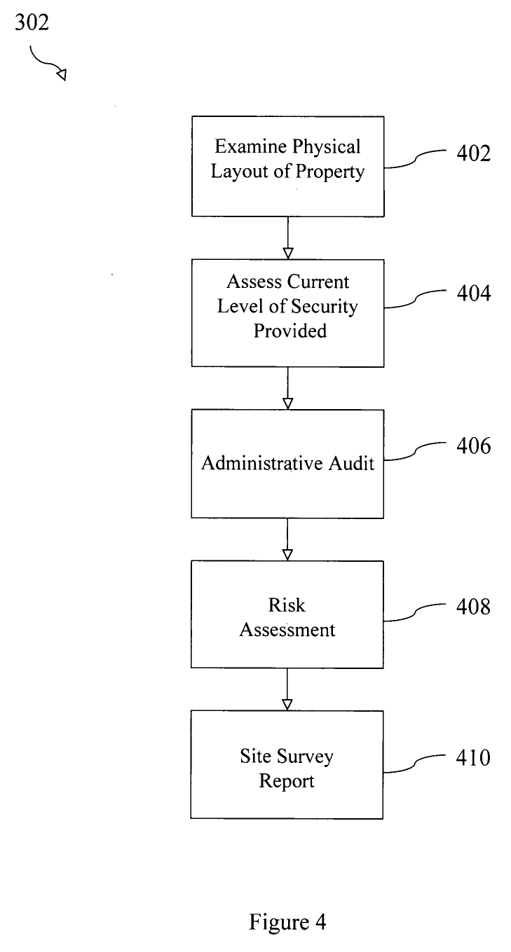

FIG. 4 shows further details of site survey step 302 of FIG. 3. In step 402, the physical layout of the campus is examined. An analysis of the physical structures themselves and the arrangement of those physical structures on the campus is performed and cataloged. Parking lot locations and passageways to and from the parking lots and the buildings are noted. Power supply points and structural versus functional supports are identified. Outer perimeter geographical features related to security are analyzed. Examples are large bodies of water, dams, mountainous terrain and proximity to nuclear strike targets such as large cities and governmental centers. Outer perimeter traffic studies are performed including traffic volume and flow patterns. A typical vehicle profile is also developed so that statistical outliers may be identified automatically. External and internal access points are identified. Student and faculty traffic patterns and volumes are identified. A typical student profile is developed. A typical faculty profile is developed. Bottlenecks to student and vehicle traffic and confusion points are identified. Problem groups both internal and external are identified such as gangs and registered sex offenders. Building vulnerabilities to blast destruction and vehicle intrusion through ramming and explosive ordinates are analyzed and cataloged.

Student surveys are taken as to the attitudes of students and parents toward security measures and video surveillance. Objective measures of security problems at the school are derived from the surveys or from existing administrative records. In the preferred embodiment, an “incident per time” measure is taken. Arrests per month, office referrals per day and “break-ins” per year are examples used in the preferred embodiment. The objective measures are used as benchmarks for comparison to determine the “success” of the security system and for school district profiling, as will be further described. An IT audit is conducted to determine the capabilities of the existing IT infrastructure. In step 404, the existing level of security provided is determined. Existing video surveillance systems, guard stations, perimeter fencing, lighting, and access point locking characteristics are all identified and cataloged.

An administrative audit is performed at step 406. In this step, non-teaching administrative functions of the school district which may be operating inefficiently and can be successfully scaled are identified and analyzed. Non-educational services such as building maintenance, student transportation services, cafeteria services, and human resources functions including payroll, health benefits and insurance administration are investigated in an attempt to recognize inefficiencies. Inefficiencies such as improper training of administrators, antiquated computer systems, payroll anomalies (such as excessive overtime, excessive vacation or sick leave, and improper task grouping) are examined. As a funding option to be described later, the preferred embodiment of the method includes outsourcing the inefficient services to the security provider at each campus. The security provider combines the inefficient services with those like services carried out for other school districts. The security provider uses state of the art equipment, specialized employees and streamlined task flow methods to provide the services to produce a cost per transaction reduction. The outsourcing of services allows for more efficient administration and a cost savings realized. The cost savings realized is used to fund the implementation of the security system.

In step 408, a risk assessment is performed. “Risk” in this disclosure is the risk associated with breach of the security system. In this step an analysis of the security vulnerabilities of a school environment and the weaknesses in building security is undertaken. Locks, windows, doors, fences, gates and buildings as well as all access portals and passenger and vehicle traffic flow are examined for security vulnerabilities. Vulnerabilities as to unauthorized access to traffic, parking, student, faculty and digital and analog communications are scrutinized. In some cases, a security breach test is conducted whereby a third party expert is hired to attempt to breach the access control system, the perimeter fencing traffic access or data integrity. Results of the security breach test are analyzed for reliability. The risk assessment is reduced to writing in a risk assessment report.

In step 410, a site survey report is created. The site survey report categorizes the existing layout of the campus. During creation of the report, the physical layout of the school is compared to a table which lists the average types and numbers of security equipment (such as cameras and door badge readers) that are required for an average access control system. From the comparison, a listing of design modules is derived that includes the minimum equipment required for implementation of the access control system. The report also describes the existing level of security equipment, and includes the risk assessment report. The site survey report also identifies potential administrative functions for outsourcing.

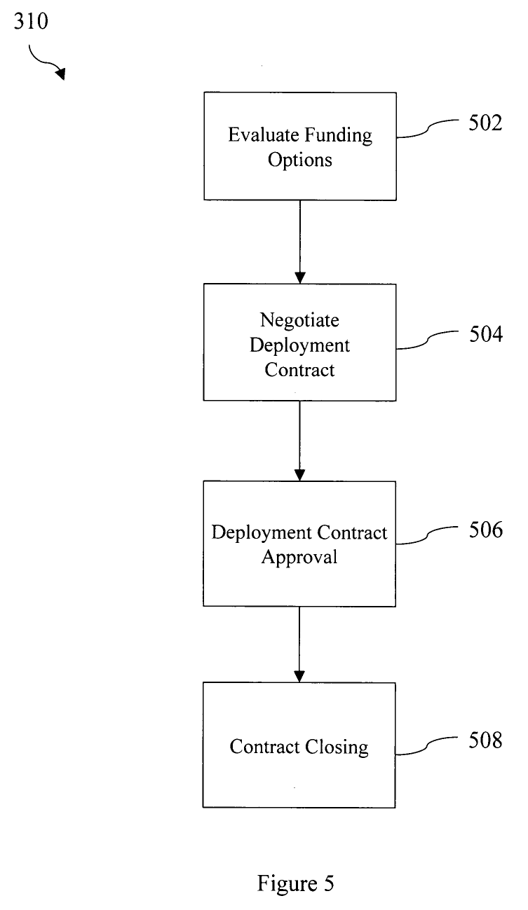

The substeps of the contract finalization step 310 from FIG. 3 are shown in reference to FIG. 5. The first step is to evaluate funding options 502. In this step, a set of available financial mechanisms are evaluated for their applicability and availability to pay for the implementation of the security system.

One funding option is participation by the school district in the outsourcing of non-educational administrative services. For example, the “scalable” services are services that may become more efficient by combining similar tasks and completing them by a dedicated set of personnel and equipment. Scalable administrative tasks which are outsourced to a single provider realize a cost savings. Payroll and administration of benefits plans are typically “scalable”. Continuing the example, it may currently cost a school district $600 per employee per year to collect and record time cards and print and distribute paychecks. An outsourced solution may be able to provide the same services for an estimated $100 per employee per year. As the outsourced solution scales to include multiple districts, the cost per employee will be further reduced. The result is a $500 savings per employee per year for the school district. The combined savings from administration of payroll for all employees of the school district, assuming the school district has 1000 employees is $500,000. Of this $500,000 savings the school district can afford to pay $100,000 for an access control system for a school. The remainder of the savings can be used for other purposes including financing of the remainder of the security system. Typical scalable administrative services include building maintenance, cafeteria services, security personnel, grounds keeping services, transportation services, insurance administration and payroll administration.

Another funding option utilizes the good will of local businesses to establish public or private sponsorships. In exchange for funding the security system, local businesses are offered an opportunity to advertise their involvement with the security of the school. Additionally, the sponsoring business may be provided advertising space on security badges and video portals. The reputation of a safe and secure school system will drive new residents and potential customers to the area and to local businesses.

Other funding options include federal, state or private grants. Up to 90% of the deployment cost of the security system may be funded by grants. An example is the United States government's “E-rate” program, which provides grants to fund telephone, Internet and IT infrastructure projects for schools and libraries.

Other funding options include leasing the access control system to the school. In this option, the security provider owns, maintains, monitors and updates the access control system greatly reducing the cost burden on the school district.

Still other funding options include financing the purchase of the access control system by the security system provider to allow extended payment to the school district over a fixed or extendable term.

Once a funding option or a combination of options is chosen, negotiate deployment contract step 504 follows. In step 504, the final cost of the implementation is calculated and negotiated. In this step, cost factors such as the description of the access control system, the number of required security personnel, the non-educational administrative services to be outsourced and the lease or length of the payout period are considered. For example, a school district having a larger campus will require larger and more complicated access control systems and more security guards than a smaller campus. Larger access control systems affect cost. As another example, a school district that outsources more non-educational administrative services then another will realize more cost savings and be able to pay for the security system sooner, but will have higher cost monthly contract costs. Higher monthly contract costs are offset by the additional savings that school district will realize by outsourcing a greater number of scalable administrative services.

The deployment contract specifies the access control equipment to be installed, the designation of the security personnel to be provided, the maintenance schedule for the access control system, the scalable administrative systems to be outsourced and the training to be supplied by the security personnel. The deployment contract also identifies the payment schedule to the security provider and for the ownership of the access control system. The contract also identifies when system upgrades are performed and how the cost of any upgrades is addressed. Those skilled in the art will recognize that other contractual provisions can be included to specify the relationship between the security provider and the school district.

Deployment contract approval step 506 follows. In this step, the deployment contract is presented to the required school boards and trustees for approval. Approval requirements in various school districts may differ.

Contract closing step 508 follows. In this step, a contract closing is held and the school district formally undertakes to implement the security system.

Referring again to FIG. 3, after contract finalization step 310 is complete, the steps of personnel clearance step 316 and badging step 312 take place. In personnel clearance step 316, each member of the engineering design team and the installation team are, identified. Additionally in this step, a detailed background check of each engineering and installation team member, employee, contractor and vendor is undertaken with respect to citizenship, work history and criminal record. Unfit candidates are replaced and their identities logged into a database. At step 312, ID badges for approved engineers and installation team personnel are created and catalogued. A database of approved personnel is also created.

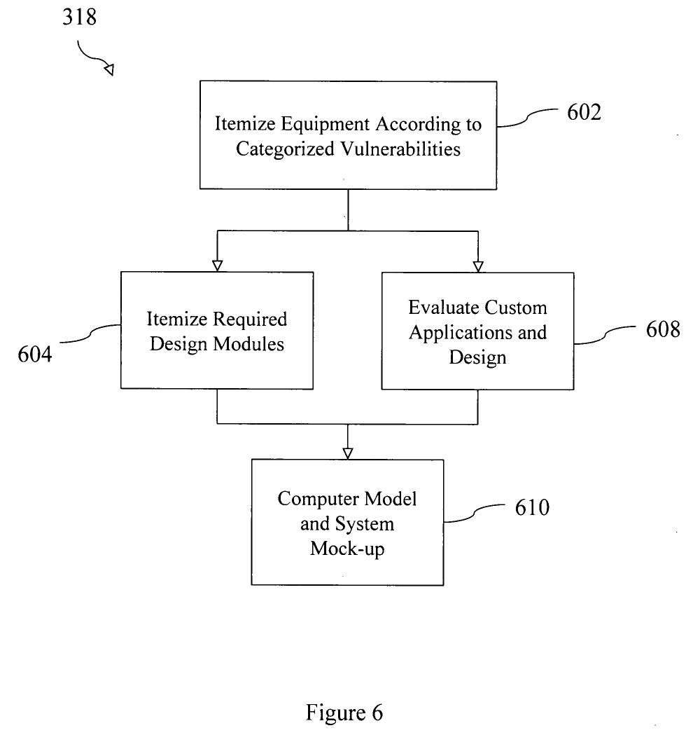

The substeps of the engineering and system design step 318 from FIG. 3 are now further described in reference to FIG. 6. At step 602, a detailed parts list and engineering specification for the access control system is created. The parts list includes computer hardware, video hardware, access control hardware and connecting wiring or wireless network equipment. The software includes operating system software, network communication software and access control software, including software to carry out the functions of the access control system. For example, artificially intelligent software capable of recognizing congregation patterns and traffic flow anomalies software is provided. Another example is software capable of a logging of statistically outlying vehicles, students and personnel. The preferred embodiment utilizes artificial intelligence technology known as the LineUp, CamSmartz, and CarDetector products available from Vigilant Video (http://www.vigilantvideo.com/products.htm). As the artificial intelligence technology in the preferred embodiment includes human face recognition, moving and stationary objects recognition, and license plate recognition.

The design specification is separated into “modules” in step 604. “Modules” are groups of related access control equipment that are packaged together in standardized numbers to facilitate handling and shipment. By way of further explanation, school campuses have many elements in common. For example, they each have classrooms, computer rooms, cafeterias, kitchens, etc. There are hallways and passageways leading between the rooms and buildings. There are typically gymnasiums and parking areas. The similar elements allow a large degree of standardization in the supply of access control and video monitoring equipment. For example, a typical sized classroom requires a pre-measured and precut length of wires, a certain number of cameras, a specific number of audio sensors, and a certain number of door locks and card readers. A packaged module containing the equipment of a typical classroom is wrapped together in color coded cellophane and is therefore easily recognizable as a classroom module. As an example, a camera group module in the preferred embodiment includes a five (5) classroom group of ten (10) cameras with 50 feet of CAT IV cable per camera and five (5) signal buffer modules. This standardization allows implementation of a modular design philosophy. The modular designs can be effectively palletized for shipment and use. Modules can be stocked according to a color scheme, a lettering scheme, or RFID identification system. School sites can then be categorized quickly by use of the module codes instead of a detailed equipment specification as in the prior art. Speed of deployment is increased. Storing efficiency is increased.

The following table shows a set of group units in a preferred embodiment:

| | | Module Color |
|---|---|---|
| Group Module Name | Group Module contents | Code |
| Camera Block | 5 color CCD Cameras | Blue |
| Module | 5-35 mm lenses | |
| | 5 TCP/IP communication cards | |
| | 50 FT. CAT IV cable | |
| | 5 signal buffers | |
| Server Conductor | 200 Mhz server | Orange |
| Block Module | backup tape drive | |
| | backup battery pack | |
| | installation pack | |
| | 50 position router switch | |
| | software bundle | |
| Parking Lot Block | 12 floodlight stacks | Yellow |
| 100,000 Sq. ft. | 12 floodlight mount kits | |
| Module | 4 mount hardware kit | |
| | 4-360 quad camera pods | |
| | power supply | |
| | wireless router | |

The types and numbers of modules are documented. In a preferred embodiment, all equipment in each module is tested to assure proper operation before packaging.

If a particular deployment requires additional security equipment not found in the set of design modules, a custom module is created. A specification of required custom modules to complete the system implementation is created in step 608. A preferred method of the present invention includes step 610 where a computer model and system mockup and system test are completed. In this step, load testing and scalability testing are completed as known in the art. Load testing and scalability testing tools such as those offered by HyPerformix, Inc. of Austin, Tex. are suitable.

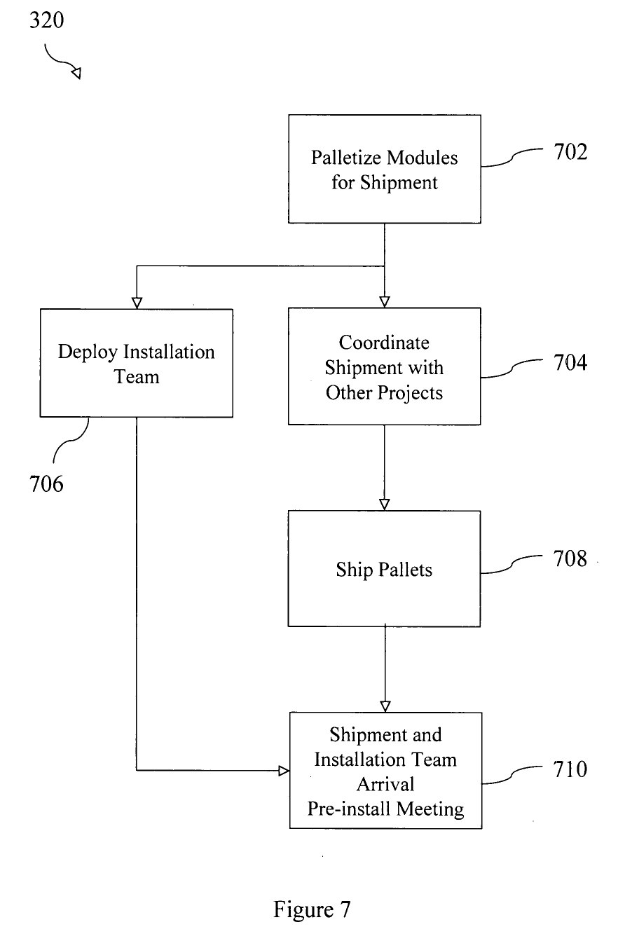

The substeps of system assembly and shipment step 320 of FIG. 3 are shown in relation to FIG. 7. The required modules of the security system are palletized for shipment in step 702. At step 704, the shipment is coordinated with other projects. Loading the palletized modules of several security system deployment locations on one vehicle if the locations are close in proximity reduces shipping costs.

The installation team is deployed to the job site at step 706. The access control system is shipped from the warehouse in step 708. At step 710, the access control system arrives at the site destination as does the installation team. A preinstall meeting is held to confirm presence of the installation team and the shipment. In another preferred embodiment the installation team is segregated into sub-teams of differing sub-specialties. The arrival of these sub-specialty groups at the job site is staggered to match an estimated benchmark schedule for implementation of the access control system.

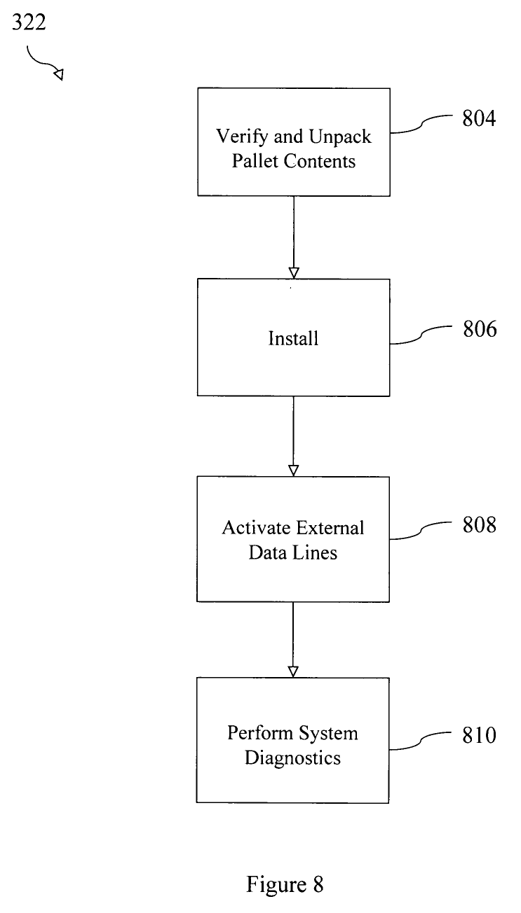

FIG. 8 shows the substeps involved in system install step 322 from FIG. 3. At step 804, the installation team verifies and unpacks the pallet contents 804 to ensure proper delivery of all required modules. At step 806, the installation team installs the access control system according to the installation plan. Integration of the existing security equipment at the school with the access control system is accomplished at this step. All access control equipment such as cameras, PTZ controllers, digital video recorders, tape backup systems, audio sensors, motion detectors, electronic door locks and the cables required to power the equipment and transmit their signals are installed. Software is installed. At step 808, external data lines for communication with the Internet are activated. All computer network equipment is checked for function and proper communication with the external data lines. At step 810, system diagnostics and tests are performed. All equipment is checked to see if it is properly connected and in proper working order. Data transmission to the wide area network controller is also verified.

Returning briefly to FIG. 3, step 324 is user acceptance testing. User acceptance testing is a process to obtain confirmation by the school district that the installed security system meets the requirements and expectations of the department contact. User acceptance testing is a final verification of the required proper functioning of the security system, emulating real world usage conditions. In this step, network loading is balanced and final network architecture changes are accomplished.

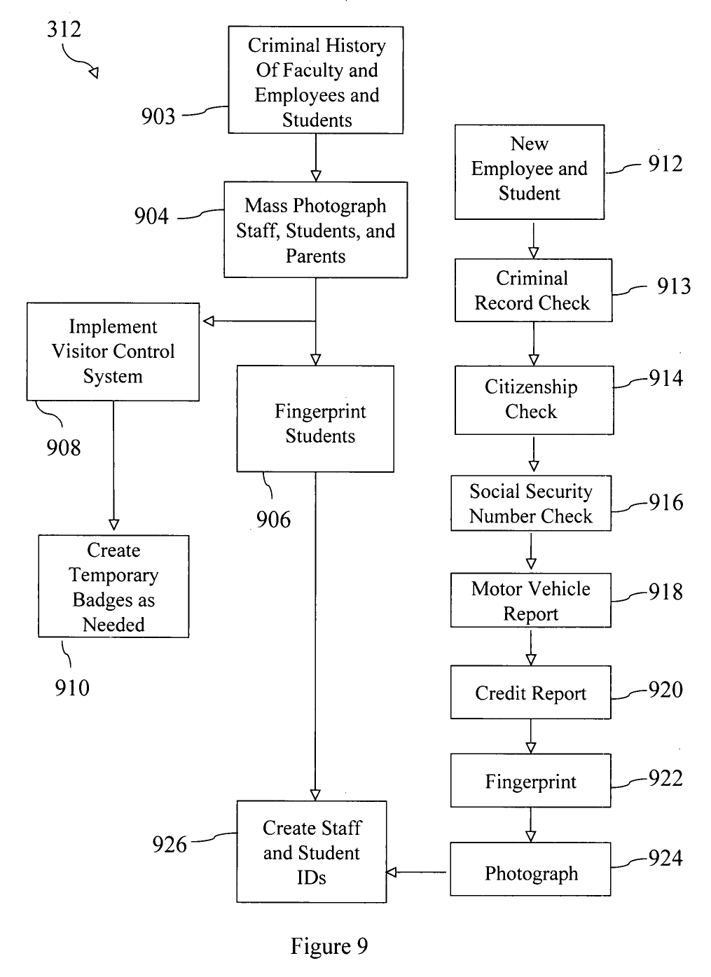

FIG. 9 shows the substeps involved in badging step 312 from FIG. 3. ID badges are required to gain access to physical locations. The badges can also be time locked to allow entry only during certain times. The badges may be magnetic strip cards or may be Radio Frequency Identification (RFID) tags capable of being detected by proximity readers. Of course, other formats of data carriers, such as smart cards containing flash memory will suffice. The ID badges are also linked to a database containing medical history of the student and familial relationships and contact numbers. At step 903, an optional criminal record check of faculty, employee and students is completed. If consent is required it is obtained in this step. At step 904, the mass photographing of staff, students, and in some cases, parents is performed. The photos of the parents are stored in a database. At step 908, a visitor control system is implemented which sets up a database and creates temporary badges as needed. At step 910, temporary visitor badges complete with photos stored in the database are printed on an as needed basis. At step 906, students are fingerprinted. A digital image of the student's fingerprint and photograph are stored in a database and used as verification as needed. The last step in badging step 312 is to make the staff and student ID badges at step 926. An ID badge is created for every student, every teacher, every administrator, and anyone else who works on the school campus (including, e.g. food vendors, medical service providers, lawn maintenance staff). Physical badges are prepared and laminated. Data entry is confirmed with the database of the access control system.

An alternate process of badging is required for new employees and students at step 912. During this process of badging, every employee of the school district and new student undergoes an extensive screening process. An optional criminal record check occurs at step 913. If consent is required it is obtained in this step. A citizenship check occurs at step 914, a social security number check occurs at step 916, a motor vehicle report check occurs at step 918 and a credit report check occurs at step 920. Fingerprints are taken at step 922 and photographs at step 924. Badges for the new students and employees are created in step 926.

Referring to FIG. 3, training step 314 follows badging step 312. In step 314, training of teachers and staff with respect to recognition of physical traits and benchmark characteristics that indicate potential school-based violence and disruptive behavior is instituted.

The behavioral training program is designed to help faculty identify a violent threat before it manifests itself. The training provides guidelines to faculty and employees as to intervention timing and methods. The training further educates faculty and employees as to existing government behavioral security requirements. A legal liaison is provided to train the faculty and employees as to school district and personal liability, racial concerns and local and state laws. Self defense and martial arts training is also provided. Weapons and explosive ordinance training is conducted at this step in the preferred embodiment.

The training includes direct staff training in classroom management, de-escalation, stress management, and other critical issues related to initiating and sustaining effective, supportive teacher-student interaction. The training further includes guiding assessment staff, administrators, and campus teams through behavior management issues in a “response to intervention model”, including instruction as to research-based interventions, multi-tiered models, universal screening, and “data based” decision making. Also included in the training is how to identify and implement effective conflict resolution programs, “no-bullying” programs and threat assessment procedures.

Still referring to FIG. 3, after user acceptance testing step 324 and training step 314 are complete, the comprehensive security program is operable and monitoring step 326 begins. At step 326, the access control system is activated. The tasks of monitoring the schools via live guards, video cameras, audio sensors, etc. and responding to alarms is performed. Monitoring step 326 also includes the step of logging trends in behaviors and alerting school staff of possible future threats recognized from the trends. As an example, a certain group of students consistently congregating in a certain place at a certain time is logged as an anomaly. As another example an unusual traffic pattern may arise in student traffic or vehicle traffic indicating an emergency or panic situation. A guard or faculty member is alerted to the situation by e-mail and by text message to a cell phone or PDA. Further, state or local authorities may also be alerted automatically to the anomaly, if required. In the preferred embodiment, the step of monitoring also includes monitoring of the access control system remotely through a wide area network or the Internet by the security system provider.

Step 328 includes the assumption and management of the scalable administration services outsourced by the security provider to generate cost savings and ultimately fund the security program deployment.

Step 330 occurs after a predetermined period of time. The step in one preferred embodiment is typically scheduled to occur after about three to five years of operation of the access control system. Step 330 involves auditing the functions of the access control system and addressing technical issues discovered. Step 330 also includes continuing education of the faculty and administrators on behavioral management. Additionally, step 330 may include the installation of additional or upgraded security equipment. Additionally, step 330 may include the generation of a security benchmark success report. The security benchmark success report requires an audit of the incidence rate parameters identified and cataloged in the site survey. The new incidence rates are compared to the incidence rates taken in the site survey to arrive at an objective indication of “success” or “failure” of the security system.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

1. A method of provisioning, installing and financing a security system in a school having a school campus, administration and a set of students comprising:
auditing the school campus to identify a set of physical buildings and a parking facility;
auditing the campus for a set of existing access control equipment;
auditing the administration for a set of scalable non-education functions;
deriving a proposed security system provisioning program from the set of existing access control equipment and from the set of scalable non-education functions;
presenting the proposed security system provisioning program to the administration;
contracting with the administration to implement the proposed security system provisioning program;
implementing the proposed security system provisioning program comprising the further steps of:
a) installing an access control system in conjunction with the set of existing access control equipment; and
b) training the administration to recognize a set of behavioral risk patterns in the set of students;
financing a first payment amount for the access control system by assuming the set of non-education functions administering the set of non-education functions to realize a savings to the administration and using the savings to pay for the access control system;

2. The method of claim 1 wherein the step of financing includes the further step of leasing the access control system to the school.

3. The method of claim 1 wherein the step of installing further comprises:
defining a set of modules according to a type and a number of pieces of security equipment; and
categorizing the access control system into the set of modules.

4. The method of claim 1 wherein the step of auditing the administration for a set of scalable non-education functions includes:
Examining one of the group of:
a) a set of payroll functions for inefficiency;
b) a set of benefit functions for inefficiency;
c) a set of cafeteria functions for inefficiency;
d) a set of transportation functions for inefficiency; and
e) a set of security functions for inefficiency.

5. The method of claim 1 wherein the step of auditing the campus for a set of existing access control equipment comprises identifying one of the group of a computer system, a video camera, a video recorder, a door badge reader, a door lock controller and a door lock.

6. The method of claim 1 wherein the step of auditing the school campus further includes identifying one or more of the group of:
a traffic pattern;
a flow pattern of the set of students;
a classroom;
a hallway;
a perimeter of the school campus;
a geography anomaly adjacent the school campus;
a lighting system of the school campus; and
a doorway.
and further comprises the step of identifying a set of vulnerabilities.

7. The method of claim 1 further comprising financing a second payment amount for the access control system by one of the group of a governmental grant and a private donation.

8. The method of claim 1 further comprising the step of:
providing an ID badge as a part of the access control system; and
providing advertising indicia on the ID badge.

9. A method of using a computer system to monitor a school campus including a set of school buildings, a parking facility, a set of vehicles and a set of students comprising;
providing a first set of video cameras in the set of school buildings and connected to the computer system generating a first set of video signals;
providing a second set of video cameras in the parking facility and connected to the computer system and generating second set of video signals;
providing a set of software on the computer system for analyzing the first set of video signals and the second set of video signals and for recognizing a traffic pattern and for recognizing a set of anomalies;
programming the set of software to:
a) log a first set of trends in the traffic flow of the set of students and send a first alert signal through the computer system;
b) log a first subset of the set of anomalies related to the set of students and send a second alert signal through the computer system;
c) log a second subset of the set of anomalies related to the set of vehicles and send a third alert through the computer system; and
d) log a second set of trends in the traffic flow of the set of vehicles and send a fourth alert signal through the computer system.

10. The method of claim 9 comprising the further steps of:
Providing an administrative staff for monitoring the set of students;
Training the administrative staff to recognize a set of behavior anomalies in the set of students;
Instructing the administrative staff to send a fifth alert signal through the computer system upon recognition of a behavioral anomaly of the set of behavioral anomalies.

11. The method of claim 9 further comprising the step of responding to the first alert signal, the second alert signal, the third alert signal and the fourth alert signal by notifying a school administration remotely through the computer system.
